(19) United States
(12) Patent Application Publication
(10) Pub. No.: US 2006/0047811 A1
(43) Pub. Date: Mar. 2, 2006

(54) Method and system of providing access to various data associated with a project

(75) Inventors: Daniel C. Lau, Issaquah, WA (US); Daniel W. Crevier, Bellevue, WA (US); Jorge A. Morinigo, Newcastle, WA (US); Robert E. Vreeland, San Jose, CA (US); Shengyong Li, San Mateo, CA (US); Stuart N. DeSpain, Seattle, WA (US); Brooke H. Nelson, Redmond, WA (US); Jeffrey A. Smith, Kirkland, WA (US); James C. Grandy, Menlo Park, CA (US); Laura J. Neumann, Kirkland, WA (US); Tony H. Lin, Mountain View, CA (US); Vianna K. V. Tam, Fremont, CA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 10/932,569

(22) Filed: Sep. 1, 2004

(51) Int. Cl. G06F 15/173

(52) U.S. Cl. 709/225

(57) ABSTRACT

Described is a system and method that enables project management across application programs, including an email program, calendar program, spreadsheet program, word processing program, note taking program and others. A central project-related view provides access to project-related data items and may display a schedule, a task list of tasks filtered as being relevant to a project, a note page related to a project, and emails relevant to the project. In addition, other application objects (file, documents, presentations and spreadsheets) are also captured in the view and presented for easy access. Metadata including a project identifier is maintained in a database for the various data items, allowing rapid location of the data items related to a project via query techniques. A project palette allows access to the items from within another application program, and a project gallery allows a user alternative access to the files related to a project.

### FIELD OF THE INVENTION

The invention relates generally to computing systems, and more particularly to managing application program data on a computer system.

### BACKGROUND

A typical computer user has various types of useful data associated with something a user is working on (which in general will be referred to herein as a “project”). For example, certain word processing documents, spreadsheets, presentations, email messages, tasks and other information such as contacts and instant messages may all be related to a project.

Conventional application programs store their data as individual files, or as a subset of a larger file, such as one email message among a large file of email messages. While it is possible to link documents to one another and/or embed documents within another, this does not help with other types of data, and is not always desirable. For example, a user may want to see a spreadsheet associated with a project, but would not want that spreadsheet to become part of another document, such as a final report. Likewise, email messages would valuable to have while working on a project, but may, for example, be highly confidential and cannot be cut and pasted into a public or shared document.

As a result of the way project-related data is maintained, a user (or team of users) is required to mentally relate the various types of data that are associated with a project. While certain types of files can be organized under a folder, not every type of data fits under a folder. For example, to access the content of email messages, a user needs to separately run an email application program and sort through many messages, or find a corresponding message folder if one has been set up for that project.

What is needed is a mechanism that allows computer users to centrally access the information that is needed at any given time, i.e., the information associated with a certain project. At the same time, it would be desirable for the mechanism to block other, unrelated information that might otherwise be distracting.

### SUMMARY OF THE INVENTION

Briefly, the present invention is directed towards a system and method by which the data of various application programs is collected for central access by a user or team of users. A database contains various program data and metadata that relates data items comprising selected file folders, contacts, tasks, email messages, calendar data, notes, clippings, and so forth to a project. Instant messages may be kept as notes in a manner that allows them to be distinguished (filtered) from other types of notes.

To relate the data, for each item of data that belongs to a project the database maintains a project identifier. If an item of data belongs to more than one project, multiple project identifiers are maintained. To this end, each item of data in the database is tracked by a record, with one field used to track to which project or projects, if any, the item belongs.

In one implementation, the metadata includes a record for each project to relate a project identifier to a project name and one or more “watch” folders that automatically associate message data that meets filtering criteria and/or files with a project.

Via the metadata, the data items and files related to a project may be quickly found using database querying techniques. Tools in the form of programs are provided to collect the various data and present it to the user in a centralized manner in relation to a project. Examples of such programs include a project center, a project gallery and a project palette which may be hosted by an application program.

The project center provides a dynamic view of a user's project data and allows the user access to the data items including messages, contact data, schedules, tasks and files. One project from among multiple displayed projects may be selected. In the project center, a number of tabs are presented, including an overview tab, a schedule tab, a mail tab, a files tab, a contacts tab, a clippings tab and a notes tab. Selecting a tab presents the corresponding data items in more detail, but only those data items associated with the project.

Contacts and messenger contacts may be associated with a project, and a user may also save instant message conversations in association with a project. To save a conversation to a project, the present invention creates a “note” flagged with data that indicates that the note is actually an instant message conversation.

To create a project, a new project wizard or the like may be run that enables a user to define metadata such as title, description, due date, notes and the like. A color may be assigned to the project, which helps a user distinguish data items and the like from other projects. Data may be imported from another project. From the wizard, watch folders may be designated, and contacts from relevant categories may be identified.

Once a project exists, items of data may be associated with a project by explicit user designation, by adding the item to a watch folder associated with a project, and by other mechanisms, such a filter rules. For example, a rule may be established such that any email message with a particular term in the subject line automatically is tagged with the project identifier.

A project palette is another tool that allows users access to project data from application programs and/or the operating system to access the project-related data items. Some activation mechanism, such as a button, keyboard key combination and/or menu item causes the project palette to be invoked. In general, the project palette may be considered a subset of the project center.

A project gallery tool allows users to access project-specific documents. Users may pre-assign a project to a new document or assign a project to an existing document.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an example architecture that allows various data to be collected in association with a project, in accordance with various aspects of the present invention;

FIG. 3 is a representation of a set of records that track projects, in accordance with various aspects of the present invention;

FIG. 4 is a representation of a set of records that track data items such as mail messages, including data items associated with a project in accordance with various aspects of the present invention;

FIG. 5 is a screenshot of a project center program that collects and presents various data items associated with a project for user access, in accordance with various aspects of the present invention;

FIG. 6 is a screenshot of an alternative project center program within an email program, in accordance with various aspects of the present invention;

FIGS. 7-12 comprise screenshots of the project center program when various tabs are selected, in accordance with various aspects of the present invention;

FIGS. 13-15 are representations of how a wizard allows a project to be created and have various data items associated therewith, in accordance with various aspects of the present invention;

FIG. 16 is a screenshot of an project pallet program window that may be hosted within another application program, in accordance with various aspects of the present invention; and

FIGS. 17 and 18 are screenshots representing a project gallery program that a user may use to access a project's related files, in accordance with various aspects of the present invention.

### DETAILED DESCRIPTION

Exemplary Operating Environment

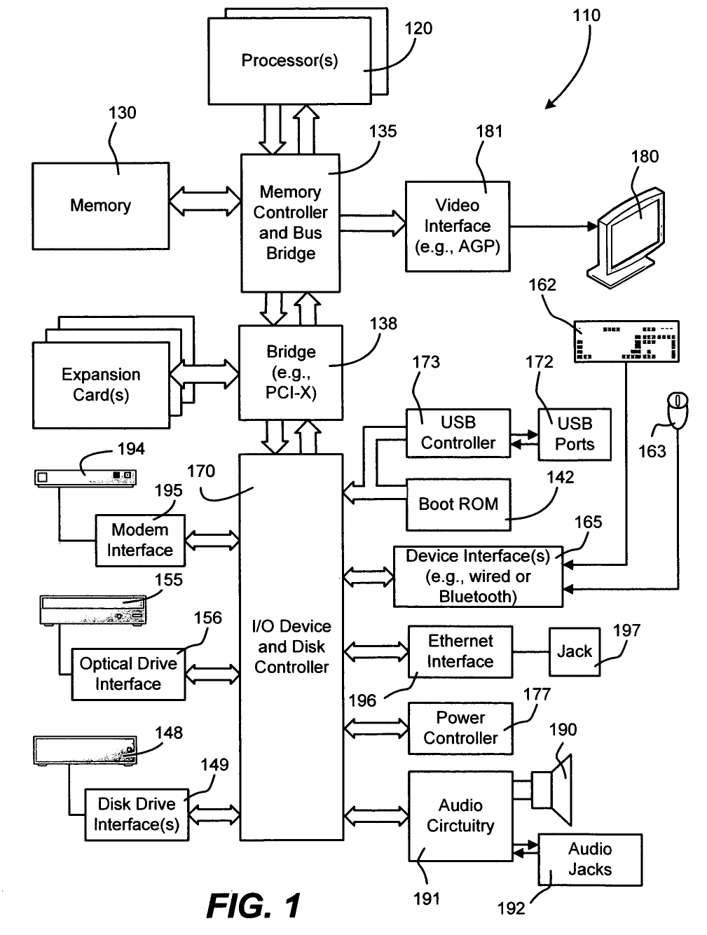

FIG. 1 illustrates an example of a suitable computing system environment on which the invention may be implemented. The computing system environment is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120 containing one ore more processors, a system memory 130, and a bus structure (e.g., memory controller/bus bridge) 135 that couples various system components including the system memory to the processing unit 120. The bus structure 135 and/or other bus bridge mechanisms 138 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and/or PCI-X.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) and random access memory (RAM). A boot ROM 142, containing the basic routines that help to transfer information between elements within computer 110, such as during start-up, may be independently coupled to the system, as shown in FIG. 1. The memory typically contains data and/or program modules that are immediately accessible to and/or presently being operated on by the processing unit 120. By way of example, and not limitation, examples include a host operating system, a guest operating system, application programs, other program modules and program data.

The computer 110 may also include other removable/non-removable, volatile/nonvolatile computer storage media. By way of example only, FIG. 1 illustrates a hard disk drive 148 and interface 149 that reads from or writes to non-removable, nonvolatile magnetic media, an optical disk drive 155 and interface 156 that reads from or writes to a removable, nonvolatile optical disk such as a CD-ROM or DVD-ROM or other optical media. Other removable/non-removable, volatile/nonvolatile computer storage media that can be used in the exemplary operating environment include, but are not limited to, magnetic tape cassettes, flash memory cards, USB drives, digital versatile disks, digital video tape, solid state RAM, solid state ROM, and the like.

The drives and their associated computer storage media, discussed above and illustrated in FIG. 1, provide storage of computer-readable instructions, data structures, program modules and other data for the computer 110. For example, the hard disk drive 148 may store the host and guest operating systems, application programs, other program modules and program data. Note that these components may be the same as or different from those loaded in the memory 130, although they are typically different instances.

A user may enter commands and information into the computer 110 through input devices such as a keyboard 162 and pointing device 163 (e.g., a mouse), and/or via other well-known input means including a tablet, electronic digitizer, microphone, trackball or touch pad. Other input devices not shown in FIG. 1 may include a joystick, game pad, satellite dish, scanner, or the like. These and other input devices are often connected to the processing unit 120 through a wired and/or wireless input interface 165 that is coupled to the system such as via an I/O device and disk controller 170, but may be connected by other interface and bus structures, such as a parallel port, game port or a universal serial bus (USB) port 172 and its controller 173. Other mechanisms that may be connected to the controller 170 include a power controller 177.

A monitor 180 or other type of display device is also connected to the system bus 121 via an interface, such as a video interface 181. The monitor 180 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 190 connected via audio circuitry 191 and/or audio jacks 192 and/or a printer, which may be connected through an output peripheral interface or the like.

The computer 110 may operate in a networked environment using logical connections to one or more remote computers, which may be a personal computer, a server, a router, a network PC, a peer device or other common network node, and typically includes many or all of the elements described above relative to the computer 110. Such networks include a local area network (LAN) and a wide area network (WAN), which may be accessed via a modem 194 and modem interface 195 and/or an Ethernet interface 196 and jack 197 and/or, but may also include other networks. Such networking environments are commonplace in offices, enterprise-wide computer networks, intranets and the Internet. It will be appreciated that the network connections shown are exemplary and other means of establishing a communications link between the computers may be used.

Providing Access to Project Data

The present invention is generally directed towards a system and method by which the data of various application programs and other programs (such as operating system components) is collected for central access by a user or team of users. As will be understood, numerous ways to implement the present invention are feasible, and only some of the alternatives are described herein. For instance, many of the examples herein will be described with reference to a Macintosh-based operating system and architecture. However, the present invention is not limited to any alternative described herein, nor is it limited to particular architecture, operating environment, platform and/or operating system. Rather, the present invention provides benefits and advantages in computing in general.

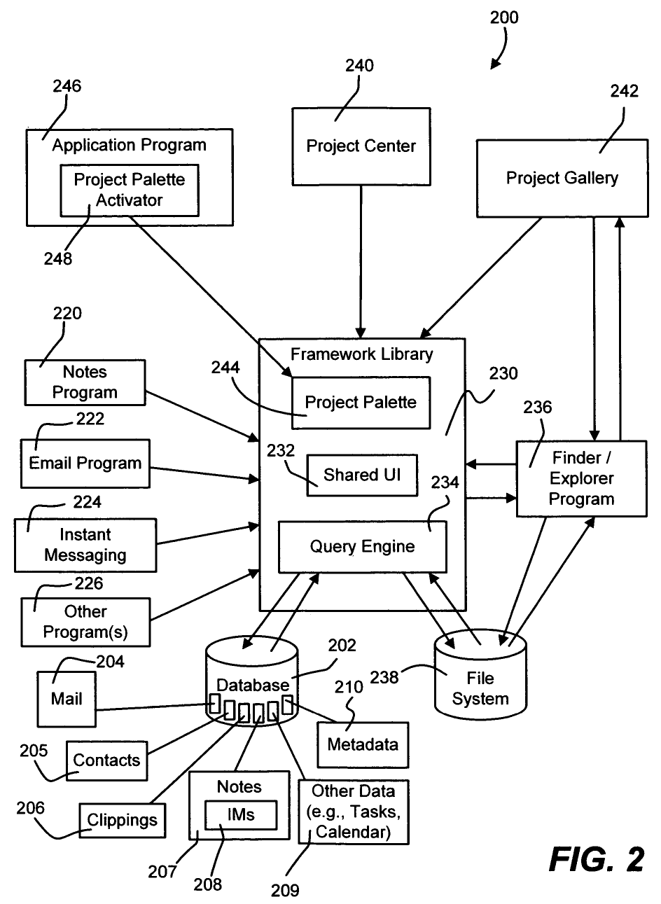

As represented in FIG. 2, there is shown an example architecture 200 in which a database 202 contains various program data 204-209 and metadata 210, which may be associated with a project, as described below. Such program data may include mail data 204 associated with an email application program, contacts data 205, clippings (e.g., text, URLS, images and so forth) 206, notes 207, instant messages 208 and any other type of data 209. Examples of such other data include tasks and calendar data, which, although represented in FIG. 2 by a single block 209, may be separately maintained. Note that as described below, in one implementation, instant messages may be kept as notes, with a distinct category designation in the metadata 210 so that the instant messages may be distinguished (filtered) from other types of notes.

In general, a notes program 220, an email program 222, an instant messaging program 224 and other programs 226 access the database 202 through a framework library 230 comprising some shared user interface functionality 232 and a query engine 234. This access provides a user with the ability to read and write notes, read and write email messages, access contacts and so on. A finder/explorer program 236 provides a user with access to files in a file system 238.

In accordance with an aspect of the present invention, other mechanisms (e.g., tools in the form of programs) are provided to collect the various data and present it to the user in a centralized manner in relation to a project. Examples of such programs include a project center 240, a project gallery 242 and a project palette 244, which may be launched from, incorporated into, or otherwise hosted by an application program 246. Note that the project palette may reside in the framework library 230.

To relate the database data 204-209 to a project, the database maintains as part of its metadata 210 a project identifier for each item of data that belongs to a project. If an item of data belongs to more than one project, multiple project identifiers are maintained. To this end, each item of data in the database 202 also has a record, with one field used to track to which project or projects, if any, the item belongs. Note that the data items are not copied per project, but rather the data items exist once but are related to a project (or multiple projects) via the data item's metadata.

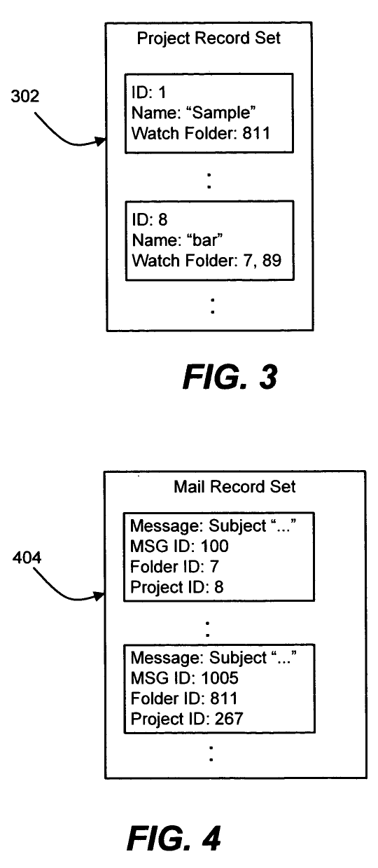

In one implementation, the metadata 210 (FIG. 2) comprises a set of records 302, one for each project, which among other things relates a project identifier to a project name assigned by the project creator, as generally represented in FIG. 3. Note that text is shown for clarity in FIG. 3, however the metadata in one implementation is actually maintained in a binary format. As described below, the user may assign one or more “watch” folder to a project; this folder information is maintained in association with the project. Note however that in one implementation, the user is only able to associate a single message watch folder to a project, along with one file system folder.

When a project is identified, any files (and/or subfolders) in the related watch folder or folders may be retrieved on demand. Messages may be put into a watch folder by a user, in which event those messages become part of the project, and messages also may be automatically transferred into a watch folder, e.g., based on the sender of the message, and/or the presence of matching text in a subject line. This may be done via existing rules mechanisms for email folders. Note that other information may appear in the project metadata, e.g., date and time created, date and time last accessed, creator, and so forth. With respect to a file system folder (or set of file system folders), the files in a folder and any subfolders of that folder are associated with the project by their being contained in that folder. It should be noted that it would be feasible to associate individual files with a project, e.g., via a list of file identifiers in the project's record set, however for purposes of simplicity and convenience to the user a folder is generally sufficiently granular.

FIG. 4 shows how data items (mail messages in this example) are associated with a project. To this end, a set of records 404 is provided in the metadata 210 (FIG. 2), one for each message, with each record having a field that may contain one or more project identifiers. Other data items such as notes, clippings, contacts, tasks and so forth are similarly tracked and have a like field for associating a data item with a project (or multiple projects). Note that a data item may not be part of any project, in which case the field can be NULL or otherwise have a value indicating no associated project.

As is readily apparent via the record set 404 and similar other records for other data items, the data items related to a project may be quickly found using database querying techniques. Further, a project may be associated with file folders, whereby any files in those folders may be quickly located via the file system 238. Messages also may be in folders, as described below, and may be found via querying.

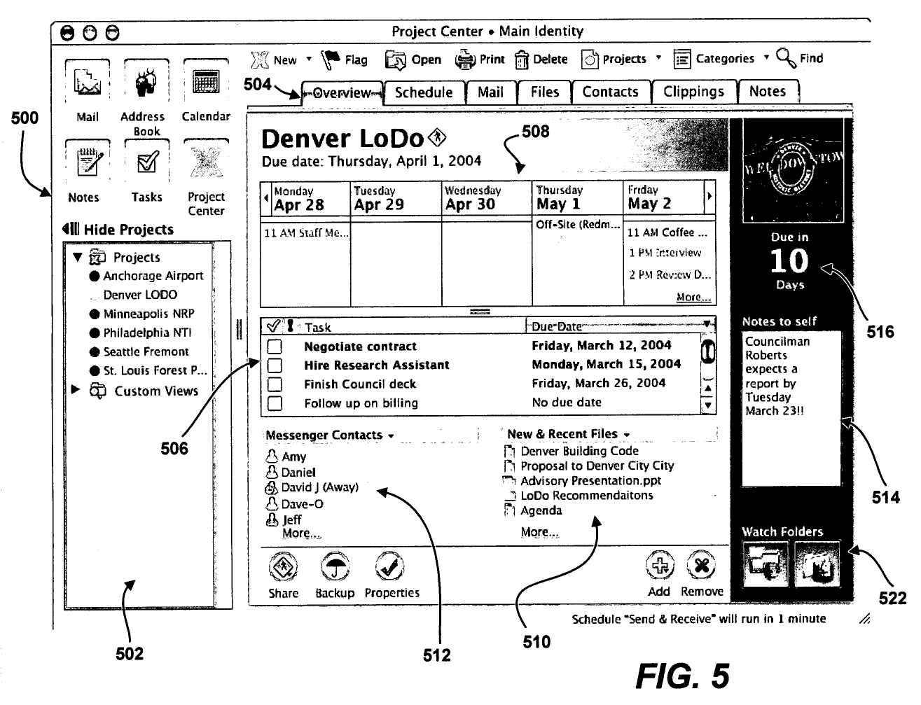

One such program that provides users with access to their project-related data items is referred to herein as a project center 240 (FIG. 2). FIG. 5 represents one example implementation of a project center user interface 500, which provides a dynamic view of a user's project data. Via a selection window 502, the project center program allows users to select a project (e.g., by name) and view the data items associated with that project, including in further detail as selected components. Note that the project center interface 500 is user-customizable as to what data items are displayed and how they are displayed, e.g., the different windows are resizable horizontally and vertically. Projects may be listed alphabetically, and although not apparent in FIG. 5, are displayed in association with a dot or other indicator that corresponds to a color assigned to the project when it was created.

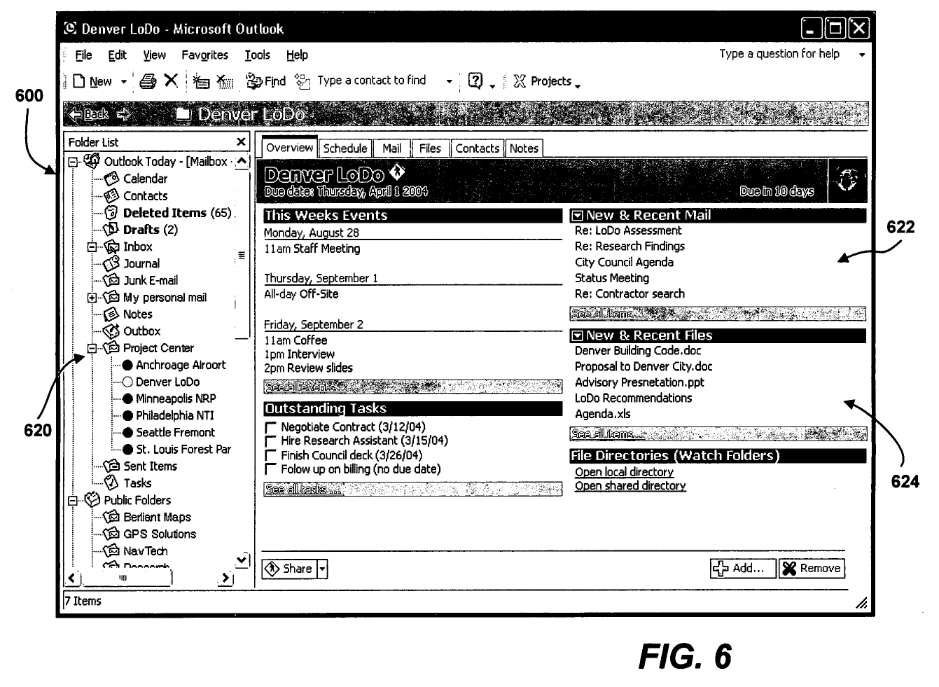

FIG. 6 shows an alternative example project center interface 600 which has been incorporated into an email/contacts/scheduling/tasks program, e.g., Microsoft® Outlook. In this implementation, the project center is selected like a folder in a folder list (tree) 620, with the projects expandable and collapsible below. Again, the project center provides the user with a view the data items associated with the selected project. For purposes of simplicity, FIG. 5 will be primarily described herein, except to note that because the user may customize to an extent what data is presented and where, in FIG. 6 the user has a view 622 of recent email messages related to the project distinct from that of the files 624, whereas in FIG. 5 the user's project-related files and messages may be combined.

In these example interfaces, a number of tabs are presented, including in FIG. 5 an overview tab 504, which when selected manually or by default when first running the project center essentially serves as the project center's home. The overview presentation provides users with a rapid summarized report of the project status, by presenting views on tasks and events 506, schedule/calendar data 508, files and/or messages 510, contacts 512 and/or notes 514. The countdown section 514 represents a primary due date less minus today's date, providing the remaining calendar days to completion. If the value is positive, countdown section 514 is shown as being “Due in X days” (where x=the value), whereas if negative, it is displayed as “Overdue X days”.

The tasks and events section 506 shows a mix of tasks and events (as selected by the user), color coded to match the color corresponding to the selected project. Each task or event may provide links to documents, contacts, clippings, and files. When selected, the task or event discloses additional metadata (time and place in the example above).

The schedule section 508 allows users to get a quick, at-a-glance view of upcoming events. The contacts section 512 provides a list of contacts, including any presence information. Note that a contact need not have a messenger account to be included. The user is able to initiate communication (chat, page, e-mail) from the list. Thus, as represented in FIG. 5, from within the project center overview presentation, a user can choose to display messenger contacts, comprising a list of project team members who also have instant messenger accounts. This list provides presence information of key team members, and allows a user to contact these people without having to switch to a different contact window.

A documents and mail window shown as new and recent files 510 shows both documents and mail linked to the project. Documents and e-mails may be launched from this window. New files can be dragged to and from the list 510 to manage linking. A local watch folder directory and a shared directory (for sharing data items with others) may be accessed via buttons 522.

The areas marked 510 and 512 in FIG. 5 comprise status lists, and show that multiple status lists can be shown at the same time depending on how much space there is available. If the user shrinks the window, status lists may be dropped off, e.g., one by one. Status lists are highly user customizable and allow the user to see what is relevant. When a user exits the project, or re-launches it, the user's preference is saved and the same list or lists are again shown. Status lists are straightforward to configure, e.g., in a current implementation only one click is needed to select a new list type, such as by clicking on the list header that brings up a menu from which a user may choose from a variety of lists types. The act of selecting a list type may trigger a database query in order to generate the type of list the user has chosen. There are types of lists such as Recent Items or Categories that may aggregate items of different types e.g., mail, notes, contacts, and so forth. Items on the status list header popup menu are not fixed but may change depending on the state of the system. For example, user-added categories automatically show up in the menu. Items in the status lists may also change depending on the state of the system (e.g., a Messenger Contacts status list shows who is currently online, offline, and the like).

Selecting an item in the status list performs a context-sensitive action. For mail, it opens the mail, for files it opens the file, and so forth. If a list has more items than there is space to show, a “More . . . ” link may be provided. Clicking this link switches the user to the appropriate tab, where they are provided with a larger view in which to browse/edit the list items. Status lists can be shared across applications and do not necessarily require any particular program to be running. The same status lists that show up in the project center can show up in the project palette or any other application that wants to show them. The status lists work with the same data, namely the data present in the database and/or available from querying the system state.

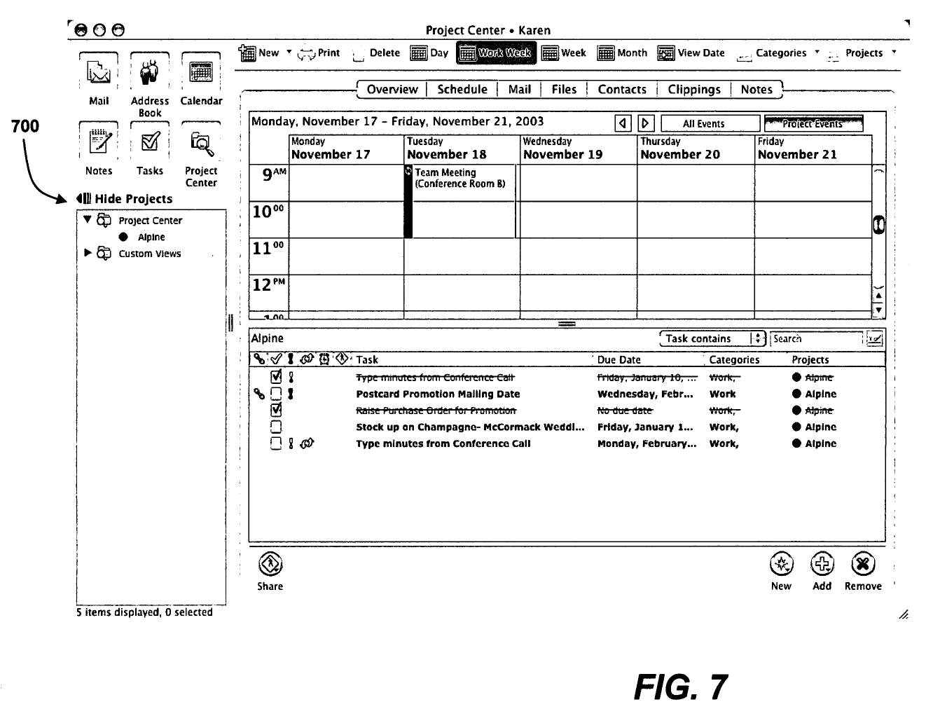

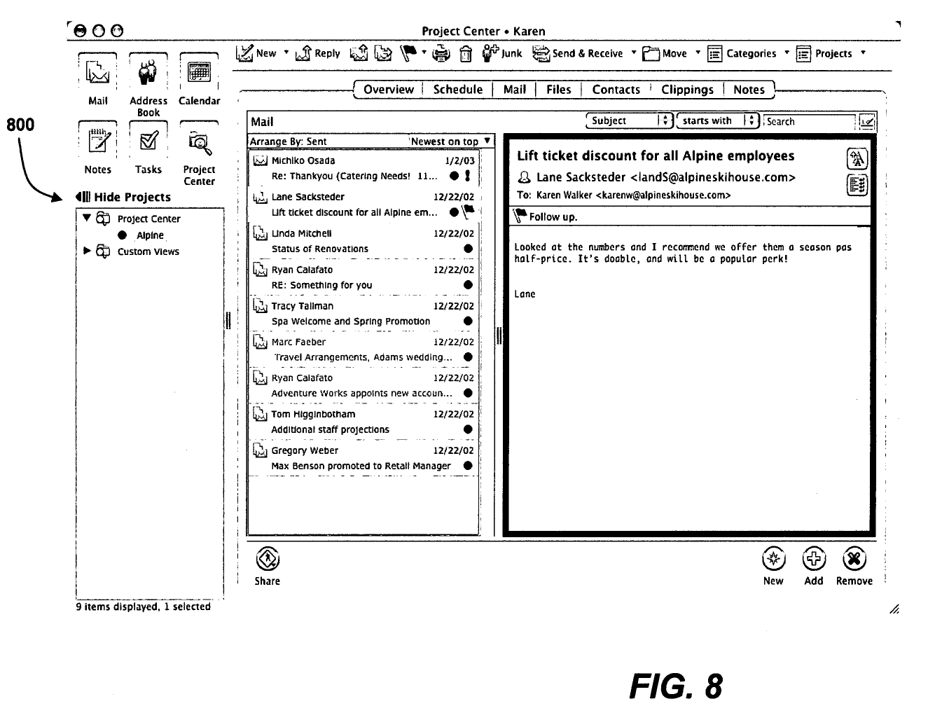

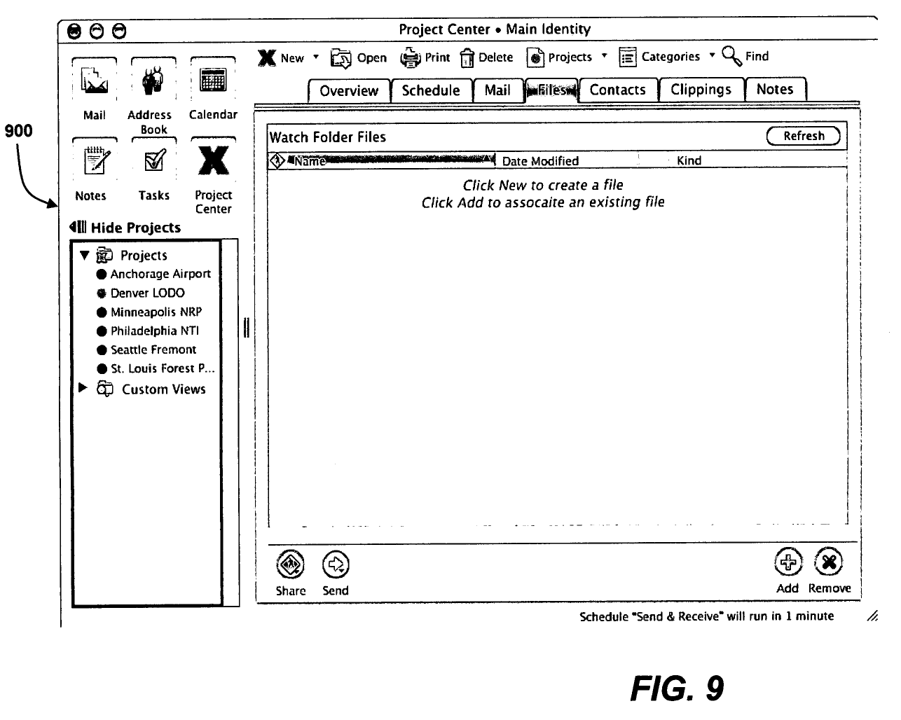

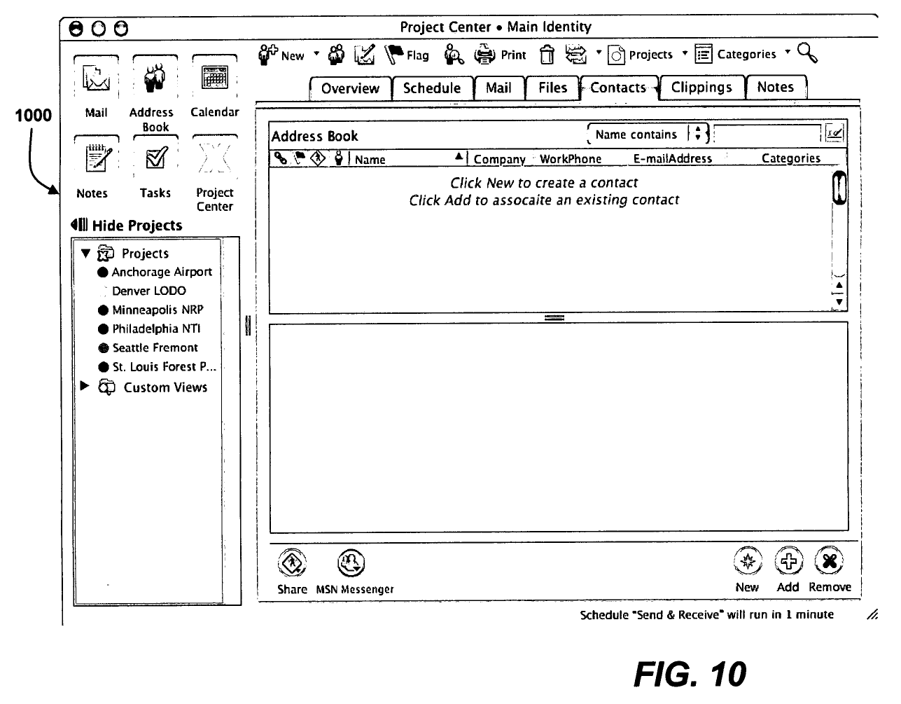

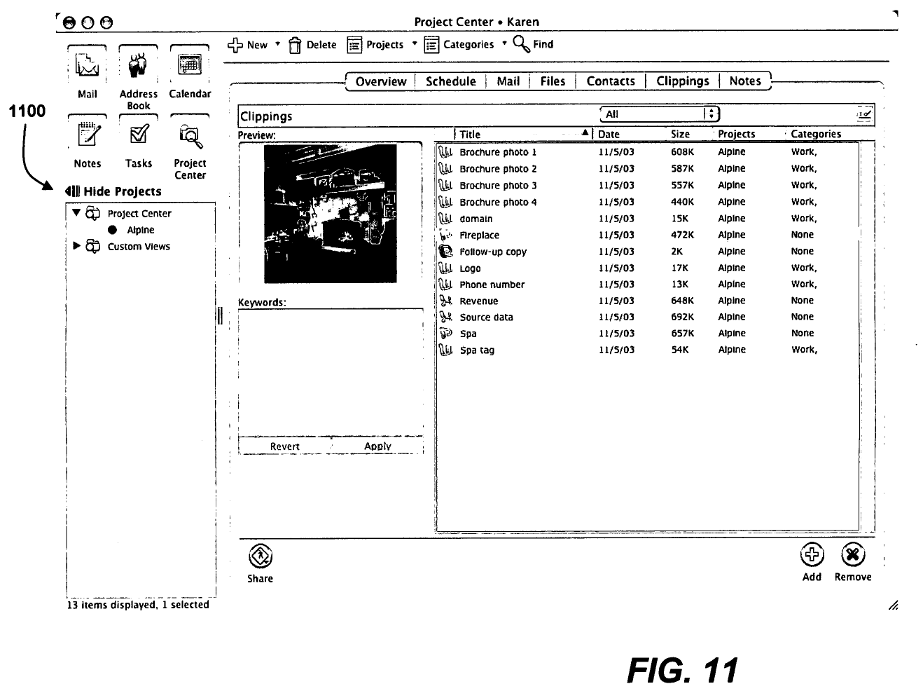

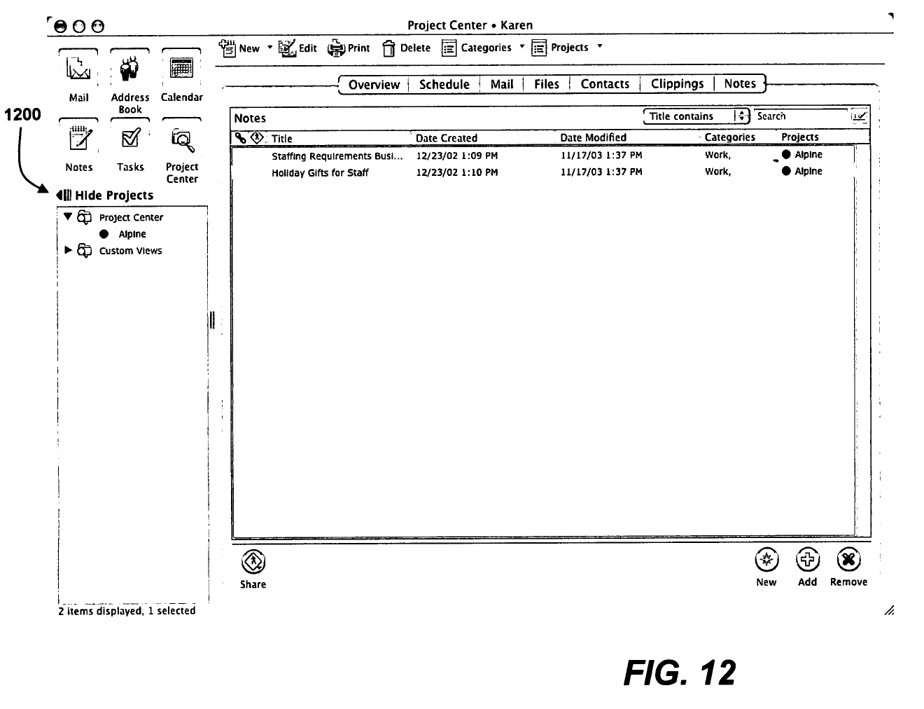

Turning to an explanation of the other selectable tabs, FIGS. 7-12 provide representations of user interface screens that appear upon selection of the other tabs, namely a schedule interface 700, a mail interface 800, a files interface 900, a contacts interface 1000, a clippings interface 1100 and a notes interface 1200. Note that unlike conventional programs that display such information, the various types of data items that are displayed are limited to those associated with the project.

Note that within the contacts tab, a user is able to see the complete list of contacts associated with a project. If contacts have Messenger accounts, their current presence statuses are indicated by the messenger icon.

In addition to providing the ability to associate messenger contacts with a project, a user may also save instant message conversations in association with a project, e.g., by hitting ‘save’ a user may save conversations to a messenger conversation history, to a project, or both. Note that a user is able to select a conversation that has been saved in the messenger conversation history and save it to a project, e.g., via a “Save to Project” button or the like. Note that once the user has set the conversation to be saved, the save does not actually take place until the user ends the chat session and closes the conversation window.

The user is able to turn on or off ‘Save in a Project’ at any time, and has the opportunity to rename the conversation, pre-named by default in the title field. To save the conversation to a project, the present invention creates a “note.” In the “Notes” tab view, messenger conversations are listed alongside the user's other notes. To filter saved messenger conversations from the other notes, a category field in the metadata 210 is marked to indicate that the note is an instant message conversation.

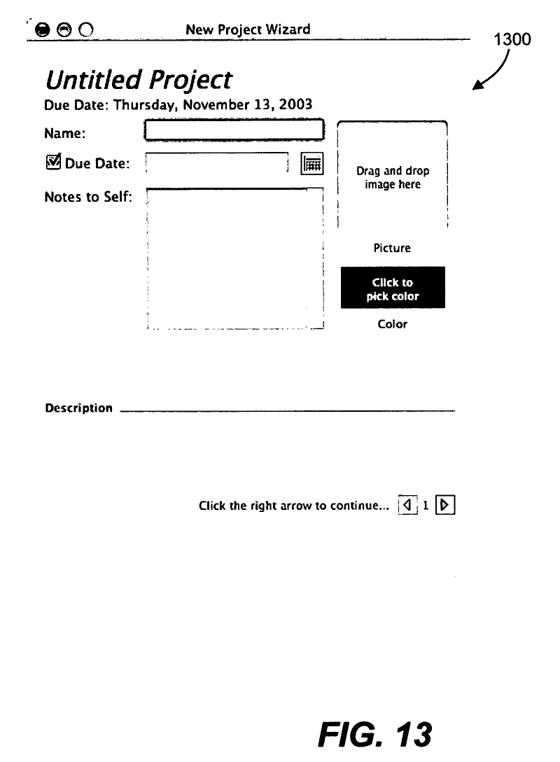

To create a project, a new project wizard or the like may be run, such as represented in FIG. 13 by the interface 1300. The new project wizard 1300 enables a user to define metadata considered important (e.g., title, description, due date, notes and the like). A color may be assigned to the project, which helps a user distinguish data items and the like from other projects. Data may be imported from another project.

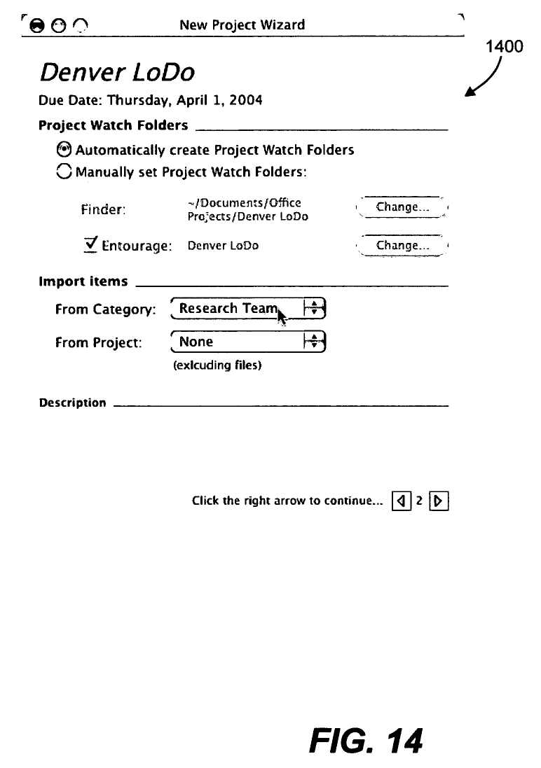

As represented in FIG. 14, the wizard advances to another interface 1400, where an existing folder that has relevant files may be associated with the project, and an email folder may be designated as a “watch folder” for associated mail. Other relevant files and/or messages may be identified, such as by dragging files into a project file drop area and/or manually assigning the data item to a project. For example, any item dragged onto a content window will be associated with the selected project. For data items, this means that they will be tagged with the project identifier, while for files, another association is made.

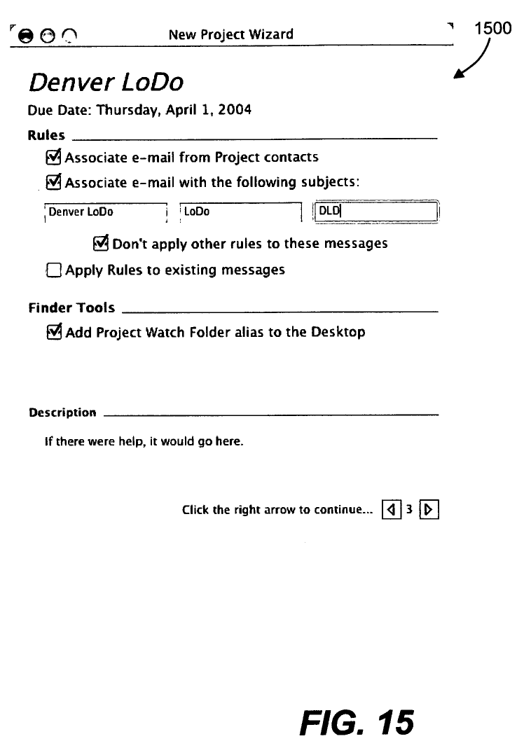

As represented in FIG. 15, the wizard advances to another interface 1500, where contacts from relevant categories may be identified. Exiting the wizard may automatically take the user to the project center, where the data items are initially displayed in the overview tab view as described above.

Once a project exists, items of data may be associated with a project by explicit user designation, by adding the item to a watch folder associated with a project, and by other mechanisms, such a filter rules. For example, a rule may be established such that any email message with a particular term in the subject line automatically is tagged with the project identifier.

The concept of watch folders automatically adds such items to a project, e.g., any message that goes into a project's watch folder for messages becomes part of the project. Similarly, any file that goes into a particular file system folder that is designated as a watch folder automatically appears when the project's files are displayed.

Mail watch folders are mail message folders that may be filled manually or via rules may be automatically populated with mail messages that meet a certain criteria. For example, a user may create a “Mary X” watch folder that automatically contains the mail messages received from Mary X. Although in one implementation there is only one mail watch folder, in alternative implementations, the user may create multiple watch folders. For example, a user may create a second watch folder that includes the messages sent directly to Mary X. Messages sent directly to Mary X to the user show up in this second watch folder as well. Subject line criteria may also be used, and so on. In any event, a message that is part of a watch folder becomes associated with a project via a project identifier in the message's associated metadata.

In accordance with another aspect of the present invention, the project palette 244 (FIG. 2) allows application programs (such as an office suite) and the operating system to access the project-related data items. To this end, the application program includes some activation mechanism 248, such as a button, keyboard key combination and/or menu item. If the database 202 includes any projects, when invoked the project palette will display data items corresponding to the first project in the list, although another selection mechanism may be provided to allow users to select another project when invoking the project palette.

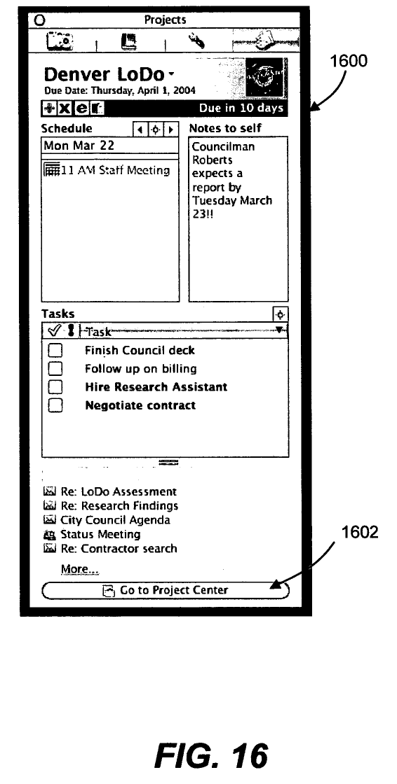

FIG. 16 shows an example project palette user interface 1600. As can be seen, in general, the project palette 244 (FIG. 2) may be considered a subset of the project center 240 hosted by another program. A button 1602 is provided to allow the user to go to the project center 240.

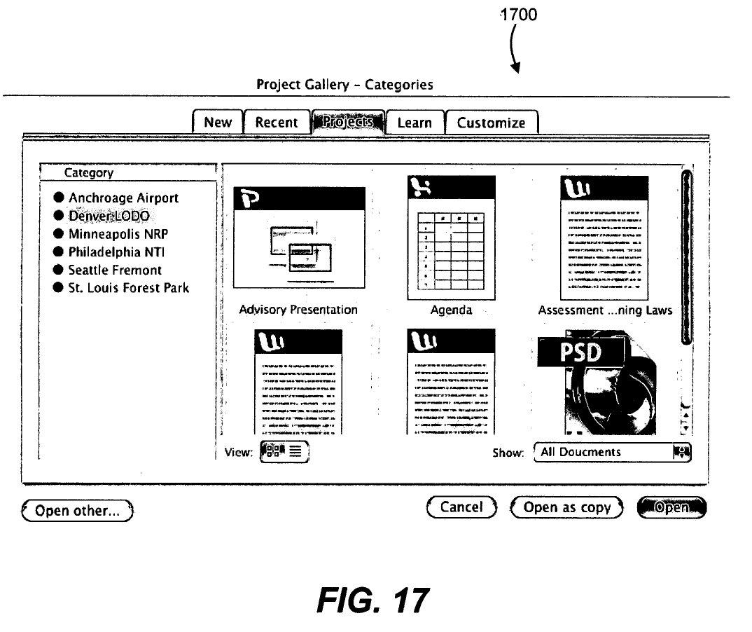

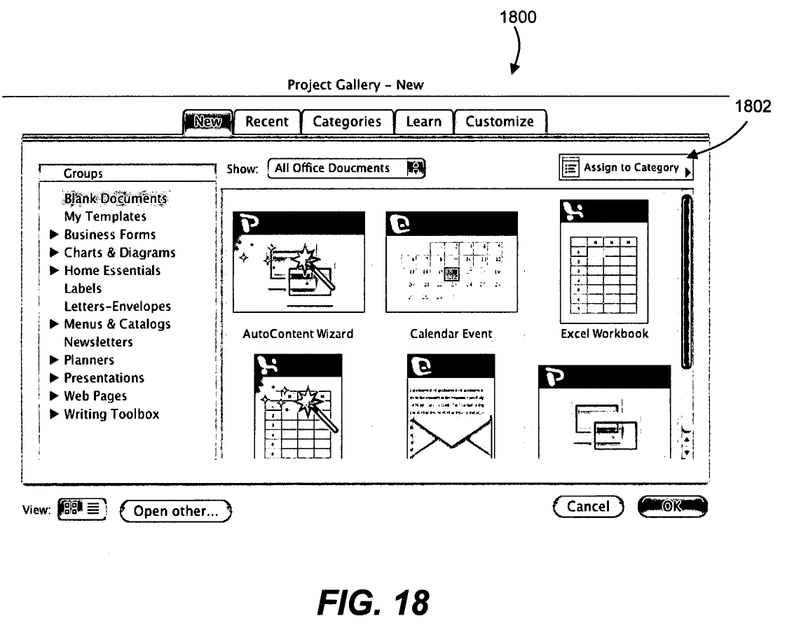

In accordance with another aspect of the present invention, the project gallery 242 (FIG. 2) allows users to open project-specific documents. To this end, an interface 1700 (FIG. 17) provides users with access to files associated with a project. On the New tab, FIG. 18, an assign to project button or the like 1802 will allow users to pre-assign a project to a new document or assign a project to an existing document. The button is active when a file has been selected in the project gallery. When the user clicks on the assign to project button projects is shown, from which a user may assign the selected file to a project.

If the user pre-assigns a project to a new document, the state is reflected once the document is opened. If the user assigns a project to an existing file, it is reflected in the thumbnail view. Assignment to multiple projects is supported. Users do not create or edit projects from the project gallery, however users may launch the new project wizard from the project gallery.

As can be seen from the foregoing detailed description, there is provided a method and system for computer users to centrally access the data items associated with a certain project. The method and system are user-customizable to a significant extent, allowing users to focus on important information.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
associating a plurality of data items with an identifier that represents a project; and
providing access to the data items via the identifier.

2. The method of claim 1 wherein associating a plurality of data items with the identifier comprises associating the identifier with at least one data item of a set of data items containing: message data, task data, calendar data, file data, clipping data, contacts data and notes data.

3. The method of claim 1 wherein associating a plurality of data items with an identifier comprises associating at least one note with the identifier, wherein the note comprises an instant message.

4. The method of claim 3 wherein the note comprising the instant message has associated data that allows the instant message note to be distinguished from at least one other type of note.

5. The method of claim 1 further comprising, associating a mail watch folder with the project in which any data item in the watch folder or subfolder of the watch folder is automatically associated with the project.

6. The method of claim 1 further comprising, associating a file system watch folder with the project in which any file in the watch folder or subfolder of the watch folder is automatically associated with the project.

7. The method of claim 1 wherein providing access to the data items via the identifier comprises obtaining the identifier based on a name assigned to the project.

8. The method of claim 1 wherein providing access to the data items via the identifier comprises querying a database with the identifier to locate data items corresponding to the project.

9. The method of claim 1 wherein providing access to the data items comprises providing a program that gives a user centralized access to at least some of the data items.

10. The method of claim 9 further comprising, hosting the program in an application program.

11. The method of claim 1 further comprising, associating a visible symbol with the project, and displaying the visible symbol in conjunction with a data item associated with the project.

12. The method of claim 11 wherein associating a visible symbol with the project comprises associating a symbol of a selected color with the project.

13. The method of claim 1 wherein providing access to the data items comprises providing a view of the data that is based on a selectable tab, with each tab corresponding to at least one type of data item.

14. The method of claim 13 further comprising, receiving a request to select an overview tab, and displaying data representative of a plurality of data items of different types in response to the request.

15. The method of claim 13 further comprising, receiving a request to select a tab from among a tab set, the tab set containing at least one of: an overview tab, a schedule tab, a mail tab, a files tab, a contacts tab, a clippings tab, and a notes tab.

16. A computer-readable medium having computer-executable instructions, which when executed perform the method of claim 1.

17. A computer-readable medium having stored thereon a data structure, comprising:
a first set of metadata that associates a project with at least one folder;
a second set of metadata that associates the project with a data item; and
wherein when provided with information corresponding to the project, a program has access to the first and second set of metadata to provide a single point of user access to data associated with the folder and to the data item.

18. The computer-readable medium of claim 17 wherein the first set of metadata and second set of metadata are contained in one or more databases, and wherein the program has access to the first and second set of metadata via at least one query.

19. The computer-readable medium of claim 17 wherein the and second set of metadata corresponds to a data item from a set containing: message data, task data, calendar data, clipping data, contacts data and notes data.

20. A computer-readable medium having computer-executable instructions, which when executed perform a method, comprising:
associating a project identifier with a file system file;
associating the project identifier with a data item other than a file system file; and
providing centralized access to the file system file and the data item by the association of each with the project identifier.

21. The computer-readable medium of claim 20 wherein associating the project identifier with the file system file comprises associating the project identifier with a folder that contains the file.

22. The computer-readable medium of claim 21 wherein associating the project identifier with the file system file writing data that identifies the folder to metadata associated with a project that corresponds to the project identifier.

23. The computer-readable medium of claim 20 wherein associating the project identifier with the data item comprises writing the project identifier to metadata associated with the data item.

24. The computer-readable medium of claim 20 wherein associating the project identifier with the data item comprises associating the project identifier with a data item of a set of data items containing: message data, task data, calendar data, clipping data, contacts data and notes data.

25. The computer-readable medium of claim 20 wherein associating the project identifier with the data item comprises associating a note with the identifier, wherein the note comprises an instant message.

26. The computer-readable medium of claim 25 wherein the note comprising the instant message has associated data that allows the instant message note to be distinguished from at least one other type of note.

27. The computer-readable medium of claim 20 further comprising, associating a mail watch folder with a project that corresponds to the project identifier, in which any data item in the watch folder or subfolder of the watch folder is automatically associated with the project.

28. The computer-readable medium of claim 20 wherein associating the project identifier with the file system file comprises associating the project identifier with a folder that contains a subfolder that contains the file.

29. The computer-readable medium of claim 20 wherein providing centralized access comprises obtaining the project identifier based on a name.

30. The computer-readable medium of claim 20 wherein providing centralized access comprises querying a database with the identifier to locate the data item and a folder that contains the file.

31. The computer-readable medium of claim 20 wherein providing centralized access comprises providing a stand-alone application program.

32. The computer-readable medium of claim 20 wherein providing centralized access comprises providing a program that is hosted in an application program.

33. The computer-readable medium of claim 20 further comprising, associating a visible symbol with the project, and displaying the visible symbol in conjunction with the data item.

34. The computer-readable medium of claim 20 further comprising, associating a visible symbol with the project, and displaying the visible symbol in conjunction with the file.

35. The computer-readable medium of claim 20 wherein providing centralized access comprises providing a plurality of views, with each view corresponding to a selectable tab.

36. The computer-readable medium of claim 35 further comprising, receiving a request to select an overview tab, and simultaneously displaying data corresponding to the data item and data corresponding to the file in response to the request.

37. The computer-readable medium of claim 35 further comprising, receiving a request to select a tab from among a tab set, the tab set containing at least one of: an overview tab, a schedule tab, a mail tab, a files tab, a contacts tab, a clippings tab, and a notes tab.

38. In a computing environment, a system comprising:
means for creating a project;
means for associating a plurality of data items with the project; and
means for providing access to the data items via the project.

39. The system of claim 38 wherein the means for associating a plurality of data items with the project comprises means for associating the project with data items of a set of data items containing: message data, task data, file data, calendar data, clipping data, contacts data and notes data.

40. The system of claim 38 wherein the means for associating a plurality of data items with the project includes a database containing metadata for at least some of the data items.
